(19) United States
(12) Patent Application Publication
(10) Pub. No.: US 2016/0188715 A1
(43) Pub. Date: Jun. 30, 2016

(54) ELECTRONIC DEVICE AND METHOD FOR SEARCHING FOR VIDEO CLIPS OF ELECTRONIC DEVICE

(71) Applicant: FIF (HONG KONG) LIMITED, Kowloon (HK)

(72) Inventor: HONG-YI CHEN, New Taipei (TW)

(21) Appl. No.: 14/734,730

(22) Filed: Jun. 9, 2015

(30) Foreign Application Priority Data
Dec. 30, 2014 (TW) 103146307

(51) Int. Cl. G06F 17/30

(52) U.S. Cl. CPC G06F 17/30852; G06F 17/30823; G06F 17/3084

(57) ABSTRACT

In a method for searching for video clips of an electronic device, a video file of the electronic device is displayed on a display screen of the electronic device. The method acquires a parameter of the video file input by an input device of the electronic device. The video file is divided into more than one video clip, and one or more specified video clips are searched from the more than one video clip according to the input parameter. The method displays the one or more specified video clips on a display screen of the electronic device.

### CROSS-REFERENCE TO RELATED APPLICATIONS

This application claims priority to Taiwanese Patent Application No. 103146307 filed on Dec. 30, 2014, the contents of which are incorporated by reference herein.

### FIELD

The subject matter herein generally relates to clip navigation technology, and particularly to an electronic device and a method for searching for video clips of the electronic device.

### BACKGROUND

A video file (e.g., a movie or a video) can be played using an electronic device. When a specified video clip of the video file needs to be navigated for playing, a timeline of the video file is manually moved by a user to search for the specified video clip. However, manual operation of moving the timeline is usually adjusted several times for obtaining the specified video clip. Time and energy of the user in these circumstances is wasted.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a searching system.

FIG. 2 is a block diagram of one embodiment of function modules of the searching system in the electronic device in FIG. 1.

FIG. 3 illustrates a flowchart of one embodiment of a method for searching for video clips of the electronic device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

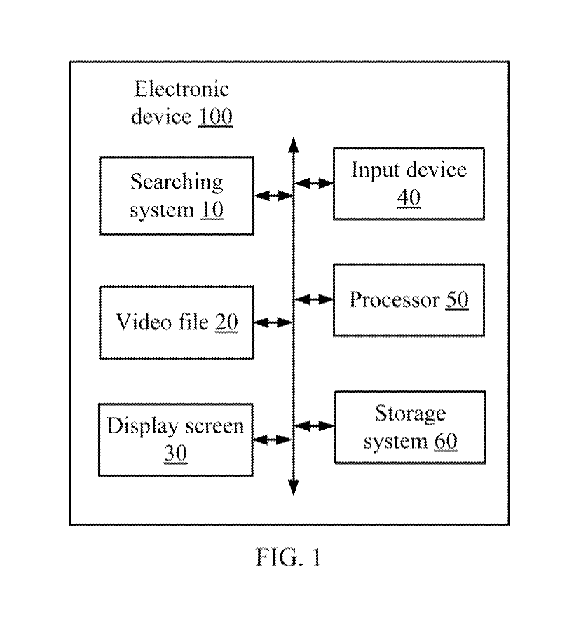

FIG. 1 illustrates a block diagram of one embodiment of an electronic device 100. Depending on the embodiment, the electronic device 100 includes a searching system 10. In one embodiment, the electronic device 100 can be a tablet computer, a notebook computer, a personal digital assistant, a mobile phone, or any other electronic device. The electronic device 100 further includes, but is not limited to, a video file 20, a display screen 30, an input device 40, at least one processor 50, and a storage system 60.

The video file 20 can be a file in a video file format including avi, wmv, flv, mpg, 3gp, mp4, mov and more, for example, a movie, an online video or a television program. The display screen 30 displays the video file 20 and other data for a user. The input device 40 can be, but is not limited to, a keyboard or a mouse connected to the electronic device 100, or a touch screen of the electronic device 100. The input device 40 inputs data to the electronic device 100. The input data can be, but is not limited to, a keyword or an image for searching one or more video clips from the video file 20.

In at least one embodiment, the storage system 60 can include various types of non-transitory computer-readable storage media. For example, the storage system 60 can be an internal storage system, such as a flash memory, a random access memory (RAM) for temporary storage of information, and/or a read-only memory (ROM) for permanent storage of information. The storage system 60 can also be an external storage system, such as a hard disk, a storage card, or a data storage medium. The at least one processor 50 can be a central processing unit (CPU), a microprocessor, or other data processor chip that performs functions of the electronic device 100.

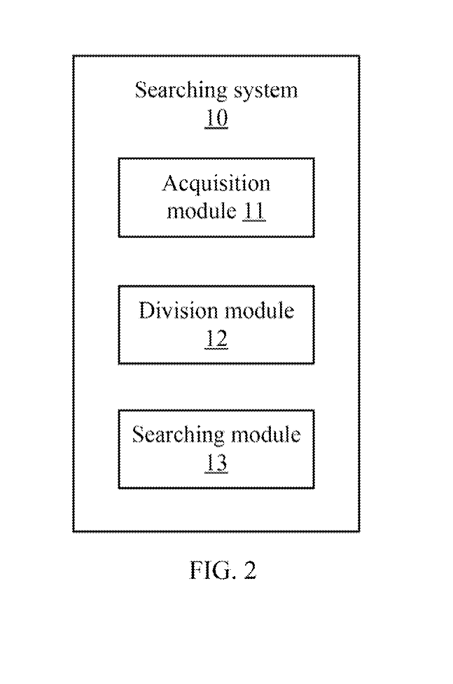

FIG. 2 is a block diagram of one embodiment of function modules of the searching system 10. In at least one embodiment, the searching system 10 can include a acquisition module 11, a division module 12, and a searching module 13. The function modules 11-13 can include computerized code in the form of one or more programs, which are stored in the storage system 60. The at least one processor 50 executes the computerized code to provide functions of the function modules 11-13.

The acquisition module 11 is configured to display a video file 20 on the display screen 30, and acquire a parameter of the video file 20 inputted by the input device 40 when one or more specified video clips of the video file 20 needs to be obtained by a user. The parameter is used for searching the one or more specified video clips from the video file 20. In the embodiment, the input parameter can be, but is not limited to, a keyword or an image input by the user.

The division module 12 is configured to divide the video file 20 into a plurality of video clips according to a preset rule. In the embodiment, the preset rule is pre-determined or user-determined according to an accuracy and speed for searching for the specified video clips. In the embodiment, the preset rule can be used to, but is not limited to, divide the video file 20 according to a predetermined interval, divide the video file 20 randomly according to a plurality of predetermined intervals, or divide the video file 20 according to the predetermined intervals and a content correlation of the video file 20. Each predetermined interval is pre-determined or user-determined, for example, five seconds. The content correlation is a correlation among content of different frames in the video file 20, for example, using the plot of the video file 20 to divide the video file 20. For example, if the video file 20 includes more than one song, the division module 12 can divide each song of the video file 20 into a video clip according to the content correlation, and further subdivide each video clip according to the predetermined intervals.

The searching module 13 is configured to search the one or more specified video clips from the divided video clips according to the input parameter, and display the specified video clips on the display screen 30. In the embodiment, the specified video clips can comprise the input keyword, comprise one or more frames that satisfy or match an image associated with the input keyword, or comprise one or more frames that satisfy or match the input image. The image associated with the input keyword can be an image searched on the Internet according to the input keyword.

In the embodiment, the searching module 13 calculates a similarity between a frame of the divided video clips and the input image or the image associated with the input keyword by using an image matching algorithm, and determines whether the similarity is greater than a preset threshold. The preset threshold can be user-determined or pre-determined, for example, a value between 70% and 90%. The image matching algorithm can be, but is not limited to, a matching algorithm based on gray scale information, a matching algorithm based on relationships structure. When the similarity is greater than the preset threshold, the searching module 13 determines that the frame of the divided video clips satisfies or matches the input image or the image associated with the input keyword.

In the embodiment, when the input parameter is the input keyword, the searching module 13 searches subtitles of the divided video clips, finds one or more video clips from the divided video clips that comprise the input keyword in the subtitles, and determines that the found video clips are the specified video clips.

In other embodiments, when the input parameter is the input keyword, the searching module 13 searches the image associated with the input keyword on the Internet, compares the image associated with the input keyword with each frame of the divided video clips, and determines whether one or more frames of the divided video clips satisfy or match the image associated with the input keyword. When one or more frames of one or more divided video clips satisfy or match the image associated with the input keyword, the searching module 13 determines that the one or more divided video clips are the specified video clips.

In the embodiment, when the input parameter is the input image, the searching module 13 compares the input image with each frame of the divided video clips, and determines whether one or more frames of the divided video clips satisfy or match the input image. When one or more frames of one or more divided video clips satisfy or match the input image, the searching module 13 determines that the one or more divided video clips are the specified video clips.

The searching module 13 is further configured to determine whether the number of the specified video clips is more than one. When the number of the specified video clips is more than one, the searching module 13 acquires a specified video clip selected by a user, determines a position of the input parameter in the selected video clip, and plays the selected video clip according to the position of the input parameter. When the number of the specified video clips is one, the searching module 13 determines a position of the input parameter in the specified video clip, and plays the specified video clip according to the position of the input parameter. When the number of the specified video clips is zero, the searching module 13 gives a prompt that searching for the specified video clips fails, inputs a parameter of the video file by using the input device, and continuously executes the iterative method to search for the specified video clips according to the input parameter.

In the embodiment, when more than one position of the input parameter can be located in a specified video clip, the searching module 13 can play the specified video clip from a preset position of the input parameter, or label the more than one position of the input parameter in the specified video clip for user input. The preset position of the input parameter can be pre-determined or user determined, for example, a first position of the input parameter in the specified video clip.

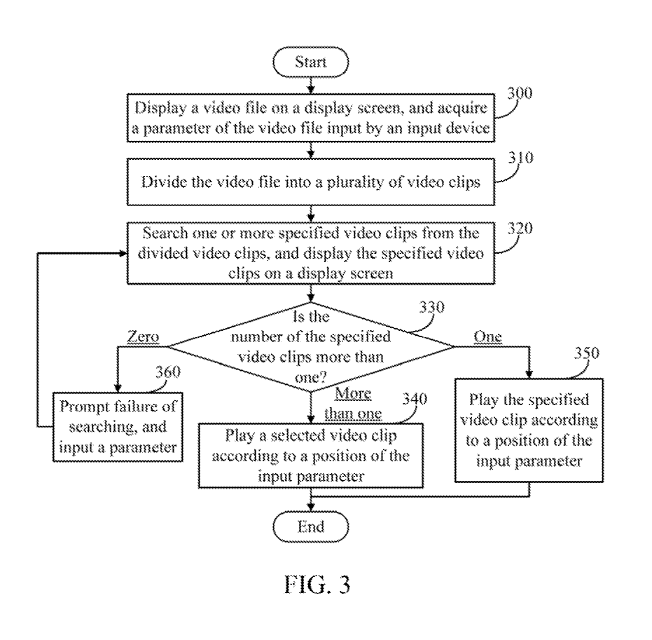

Referring to FIG. 3, a flowchart is presented in accordance with an example embodiment. The example method is provided by way of example, as there are a variety of ways to carry out the method. The method described below can be carried out using the configurations illustrated in FIG. 1 and FIG. 2, for example, and various elements of these figures are referenced in explaining example method. Each block shown in FIG. 3 represents one or more processes, methods, or subroutines, carried out in the exemplary method. Furthermore, the illustrated order of blocks is by example only and the order of the blocks can be changed. Additional blocks may be added or fewer blocks may be utilized, without departing from this disclosure. The exemplary method can begin at block 300. Depending on the embodiment, additional blocks can be added, others removed, and the ordering of the blocks can be changed.

At block 300, an acquisition module displays a video file of an electronic device on a display screen of the electronic device, and acquires a parameter of the video file input by an input device of the electronic device when one or more specified video clips of the video file needs to be obtained by a user. The parameter is used for searching the one or more specified video clips from the video file. In the embodiment, the input parameter can be, but is not limited to, a keyword or an image input by the user.

At block 310, a division module divides the video file into a plurality of video clips according to a preset rule. In the embodiment, the preset rule is pre-determined or user-determined according to an accuracy and speed for searching for the specified video clips. In the embodiment, the preset rule can be used to, but is not limited to, divide the video file according to a predetermined interval, divide the video file randomly according to a plurality of predetermined intervals, or divide the video file according to the predetermined intervals and a content correlation of the video file. Each predetermined interval is pre-determined or user-determined, for example, five seconds. The content correlation is a correlation among content of different frames in the video file, for example, using the plot of the video file to divide the video file.

At block 320, a searching module searches the one or more specified video clips from the divided video clips according to the input parameter, and displays the specified video clips on a display screen of the electronic device. In the embodiment, the specified video clips can comprise the input keyword, comprise one or more frames that satisfy or match an image associated with the input keyword, or comprise one or more frames that satisfy or match the input image. The image associated with the input keyword can be an image searched on the Internet according to the input keyword.

In the embodiment, the searching module calculates a similarity between a frame of the divided video clips and the input image or the image associated with the input keyword by using an image matching algorithm, and determines whether the similarity is greater than a preset threshold. The preset threshold can be user-determined or pre-determined, for example, a value between 70% and 90%. The image matching algorithm can be, but is not limited to, a matching algorithm based on gray scale information, a matching algorithm based on relationships structure. When the similarity is greater than the preset threshold, the searching module determines that the frame of the divided video clips satisfies or matches the input image or the image associated with the input keyword.

At block 330, the searching module determines whether the number of the specified video clips is more than one. If the number of the specified video clips is more than one, block 340 is implemented. If the number of the specified video clips is one, block 350 is implemented. If the number of the specified video clips is zero, block 360 is implemented, and block 320 is repeated to execute the iterative method to continuously search the specified video clips from the divided video clips according to the input parameter.

At block 340, the searching module acquires a specified video clip selected by a user, determines a position of the input parameter in the selected video clip, and plays the selected video clip according to the position of the input parameter.

At block 350, the searching module determines a position of the input parameter in the specified video clip, and plays the specified video clip according to the position of the input parameter.

At block 360, the searching module gives a prompt that searching for the specified video clips fails, and inputs a parameter of the video file by using the input device.

In the embodiment, after the division module acquires a divided video clip, block 310 and block 320 can be executed simultaneously for improving the efficiency of searching for the specified video clips.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for searching for video clips of an electronic device, the method comprising:
displaying, on a display screen of the electronic device, a video file of the electronic device;
receiving, from an input device of the electronic device, a parameter of the video file input;
dividing, by a processor of the electronic device, the video file into a plurality of video clips;
searching, by the processor, one or more specified video clips from the plurality of video clips according to the input parameter; and
displaying, on a display screen of the electronic device, the one or more specified video clips.

2. The method according to claim 1, further comprising:
determining whether the number of the specified video clips is more than one;
acquiring a specified video clip selected by a user, determining a position of the input parameter in the selected video clip, and playing the selected video clip according to the position of the input parameter when the number of the specified video clips is more than one;
determining a position of the input parameter in a specified video clip, and playing the specified video clip according to the position of the input parameter when the number of the specified video clips is one; and
giving a prompt that searching for the specified video clips fails, inputting a parameter on the video file by using the input device, and searching the specified video clips from the plurality of video clips according to the input parameter when the number of the specified video clips is zero.

3. The method according to claim 1, wherein the input parameter is a keyword or an image input by the input device.

4. The method according to claim 1, wherein the specified video clips comprise a keyword input by the input device, one or more frames that match an image associated with the keyword, or one or more frames that match an image input by the input device.

5. The method according to claim 1, wherein when the input parameter is a keyword input by the input device, the specified video clips are searched from the plurality of video clips by:
searching subtitles of the plurality of video clips, finding one or more video clips from the plurality of video clips that comprise the keyword in the subtitles, and determining the found video clips as the specified video clips; or
searching an image associated with the keyword on the Internet, comparing the image associated with the keyword with each frame of the plurality of video clips, and determining one or more video clips as the specified video clips when one or more frames of the one or more video clips match the image associated with the keyword.

6. The method according to claim 1, wherein when the input parameter is an image input by the input device, the specified video clips are searched from the plurality of video clips by:
comparing the image with each frame of the plurality of video clips;
determining whether one or more frames of the plurality of video clips match the image; and
determining one or more video clips as the specified video clips when one or more frames of the one or more video clips match the image.

7. An electronic device for searching for video clips of the electronic device, the electronic device comprising:
a video file;
a display screen, an input device, and at least one a processor; and
a storage system that stores one or more programs, when executed by the at least one processor, cause the at least one processor to:
display the video file on the display screen;
acquire a parameter of the video file input by the input device;
divide the video file into a plurality of video clips;
search one or more specified video clips from the plurality of video clips according to the input parameter; and
display the one or more specified video clips on the display screen.

8. The electronic device according to claim 7, wherein the one or more programs further cause the at least one processor to:
determine whether the number of the specified video clips is more than one;
acquire a specified video clip selected by a user, determine a position of the input parameter in the selected video clip, and play the selected video clip according to the position of the input parameter when the number of the specified video clips is more than one;
determine a position of the input parameter in a specified video clip, and play the specified video clip according to the position of the input parameter when the number of the specified video clips is one; and
give a prompt that searching for the specified video clips fails, input a parameter on the video file by using the input device, and search the specified video clips from the plurality of video clips according to the input parameter when the number of the specified video clips is zero.

9. The electronic device according to claim 7, wherein the input parameter is a keyword or an image input by the input device.

10. The electronic device according to claim 7, wherein the specified video clips comprise a keyword input by the input device, one or more frames that match an image associated with the keyword, or one or more frames that match an image input by the input device.

11. The electronic device according to claim 7, wherein when the input parameter is a keyword input by the input device, the specified video clips are searched from the plurality of video clips by:
searching subtitles of the plurality of video clips, finding one or more video clips from the plurality of video clips that comprise the keyword in the subtitles, and determining the found video clips as the specified video clips; or
searching an image associated with the keyword on the Internet, comparing the image associated with the keyword with each frame of the plurality of video clips, and determining one or more video clips as the specified video clips when one or more frames of the one or more video clips match the image associated with the keyword.

12. The electronic device according to claim 7, wherein when the input parameter is an image input by the input device, the specified video clips are searched from the plurality of video clips by:
comparing the image with each frame of the plurality of video clips;
determining whether one or more frames of the plurality of video clips match the image; and
determining one or more video clips as the specified video clips when one or more frames of the one or more video clips match the image.

13. A non-transitory storage medium having stored thereon instructions that, when executed by a processor of an electronic device, causes the processor to perform a method for searching for video clips of the electronic device, wherein the method comprises:
displaying, on a display screen of the electronic device, a video file of the electronic device;
receiving, from an input device of the electronic device, a parameter of the video file input;
dividing, by the processor, the video file into a plurality of video clips;
searching, by the processor, one or more specified video clips from the plurality of video clips according to the input parameter; and
displaying, on a display screen of the electronic device, the one or more specified video clips.

14. The non-transitory storage medium according to claim 13, wherein the method further comprises:
determining whether the number of the specified video clips is more than one;
acquiring a specified video clip selected by a user, determining a position of the input parameter in the selected video clip, and playing the selected video clip according to the position of the input parameter when the number of the specified video clips is more than one;
determining a position of the input parameter in a specified video clip, and playing the specified video clip according to the position of the input parameter when the number of the specified video clips is one; and
giving a prompt that searching for the specified video clips fails, inputting a parameter on the video file by using the input device, and searching the specified video clips from the plurality of video clips according to the input parameter when the number of the specified video clips is zero.

15. The non-transitory storage medium according to claim 13, wherein the input parameter is a keyword or an image input by the input device.

16. The non-transitory storage medium according to claim 13, wherein the specified video clips comprise a keyword input by the input device, one or more frames that match an image associated with the keyword, or one or more frames that match an image input by the input device.

17. The non-transitory storage medium according to claim 13, wherein when the input parameter is a keyword input by the input device, the specified video clips are searched from the plurality of video clips by:
searching subtitles of the plurality of video clips, finding one or more video clips from the plurality of video clips that comprise the keyword in the subtitles, and determining the found video clips as the specified video clips; or
searching an image associated with the keyword on the Internet, comparing the image associated with the keyword with each frame of the plurality of video clips, and determining one or more video clips as the specified video clips when one or more frames of the one or more video clips match the image associated with the keyword.

18. The non-transitory storage medium according to claim 13, wherein when the input parameter is an image input by the input device, the specified video clips are searched from the plurality of video clips by:
comparing the image with each frame of the plurality of video clips;
determining whether one or more frames of the plurality of video clips match the image; and
determining one or more video clips as the specified video clips when one or more frames of the one or more video clips match the image.
